(19) United States
(12) Patent Application Publication
(10) Pub. No.: US 2025/0187564 A1
(43) Pub. Date: Jun. 12, 2025

(54) WIPER BLADE DEVICE, WINDSHIELD WIPER, AND METHOD FOR OPERATING THE WINDSHIELD WIPER

(71) Applicant: Robert Bosch GmbH, Stuttgart (DE)

(72) Inventors: Raf Greunlinx, Zolder (BE); Aleksandar Stanisic, Belgrade (RS); Alexander Goeller, Baiersbronn (DE); Andrija Terentic, Belgrad (RS); Denis Parenta, Veternik (RS); Frank Reinig, Buehlertal (DE); Harald Rapp, Buehl (DE); Michael Kruse, Sinzheim (DE); Najdan Jocic, Pancevo (RS); Salvatore Formisano, Malsch (DE); Sascha Geissler, Lichtenau (DE); Steven Lenaerts, Tienen (BE); Stijn Truyens, Tienen (BE)

(21) Appl. No.: 18/846,419

(22) PCT Filed: Mar. 14, 2023
(86) PCT No.: PCT/EP2023/056403

§ 371 Date: Sep. 12, 2024

(30) Foreign Application Priority Data
Apr. 6, 2022 (DE) 10 2022 203 434.1

(51) Int. Cl. B60S 1/38; B60S 1/48; B60S 1/52

(52) U.S. Cl. CPC B60S 1/381; B60S 1/481; B60S 1/524

(57) ABSTRACT

The invention is based on a wiper blade device (10a; 10b) comprising at least one wiper lip (12a; 12b) for wiping a surface (14a) and comprising at least one wind deflector unit (16a; 16b) for utilizing an airstream to press the wiper lip (12a; 12b) against the surface (14a), comprising a fluid output unit (18a; 18b) and comprising a fluid unit (20a) for directing wiper fluid to a fluid output unit, which unit comprises at least one fluid channel (22a) delimited by the wind deflector unit (16a; 16b), which channel extends along a longitudinal axis (24a; 24b) of the wind deflector unit (16a; 16b) over at least 10% of a maximum longitudinal extension (26a) of the wind deflector unit (16a; 16b).

It is proposed that the fluid output unit (18a; 18b) comprises at least one further fluid channel (28a; 28b), which extends along the longitudinal axis (24a) of the wind deflector unit (16a; 16b) over at least 10% of the maximum longitudinal extension (26a) of the wind deflector unit (16a; 16b), and which is arranged at least partially outside the wind deflector unit (16a; 16b) on an outer side (30a; 30b) of the wind deflector unit (16a; 16b).

### BACKGROUND

Previously proposed is a wiper blade device comprising at least one wiper lip for wiping a surface and comprising at least one wind deflector unit for utilizing an airstream to press the wiper lip against the surface, comprising a fluid output unit and comprising a fluid unit for guiding wiper fluid to a fluid output, which unit comprises at least one fluid channel delimited by the wind deflector unit, which channel extends along a longitudinal axis of the wind deflector unit over at least 10% of a maximum longitudinal extension of the wind deflector unit.

### SUMMARY

The invention is based on a wiper blade device comprising at least one wiper lip for wiping a surface and comprising at least one wind deflector unit for utilizing an airstream to press the wiper lip against the surface, comprising a fluid output unit and comprising a fluid unit for guiding wiper fluid to a fluid output, which comprises at least one fluid channel delimited by the wind deflector unit, which fluid channel extends along a longitudinal axis of the wind deflector unit over at least 10% of a maximum longitudinal extension of the wind deflector unit.

It is proposed that the fluid output unit comprises at least one further fluid channel which extends along a longitudinal axis of the wind deflector unit over at least 10% of a maximum longitudinal extension of the wind deflector unit and which is arranged at least partially outside the wind deflector unit on an outer side of the wind deflector unit.

The term “wiper blade device” is intended to mean at least one part, preferably a subassembly, of a wiper blade, preferably a windshield wiper blade. The wiper blade device can also comprise the entire wiper blade, preferably the entire windshield wiper blade. The wiper blade device is advantageously provided for use on a vehicle. The wiper blade device is preferably intended for cleaning a surface, preferably a windshield on a vehicle. The wiper blade device is preferably part of a windshield wiper for a vehicle. The wiper blade device could also be designed as an accessory and/or spare part of a windshield wiper. The wiper blade device is preferably coupled to a wiper arm unit of a windshield wiper in a mounted state for cleaning a vehicle windshield.

Preferably, the wind deflector unit is intended to deflect the airstream and/or to be used for pressing the wiper blade, in particular the wiper blade device, against the surface, preferably a vehicle windshield. Preferably, the wind deflector unit comprises at least one concave upstream surface. The wiper blade device preferably comprises a wiper base body formed from at least one elastic material, which is connected to the wiper lip. The wiper lip can be connected to the wiper base body in a bonded manner. The term “connected in a bonded manner” is intended to mean that the mass parts are held together by atomic or molecular forces, such as in soldering, welding, gluing and/or vulcanization. The longitudinal axis of the wind deflector unit extends parallel to a main direction of extension of the wind deflector unit. In this context, the term “main direction of extension” of an object is intended to mean a direction which extends parallel to a longest edge of a smallest geometrical cuboid which just completely encloses the object. Preferably, the maximum longitudinal extension of the wind deflector unit corresponds to the longest edge of a smallest geometric cuboid that just completely encloses the wind deflector unit.

The fluid unit is provided for transporting wiper fluid and/or cleaning fluid and for this purpose comprises at least the fluid channel delimited by the wind deflector unit. The fluid unit is further provided for dispensing wiper fluid onto the surface, preferably in a direction which is at least substantially perpendicular to the longitudinal axis of the wind deflector unit. The phrase “at least substantially perpendicular” is intended to mean an orientation of a direction which includes an angle between 85° and 95° with a reference direction, in particular an angle between 86° and 94°, advantageously an angle between 87° and 93°, particularly advantageously an angle between 88° and 92°, preferably an angle between 89° and 91° and particularly preferably an angle of 90°. Preferably, the fluid channel of the fluid unit is designed as a channel-like clearance within the wind deflector unit. The fluid channel can alternatively or additionally be designed as a channel delimited by a hose-like and/or at least one tube-like element, which is arranged within the wind deflector unit. The fluid channel of the fluid unit is provided for guiding a fluid, preferably a wiper fluid and/or cleaning fluid. Preferably, the fluid channel of the fluid unit comprises at least one, preferably at least two, open end region(s) along its maximum extension. Preferably, the at least one fluid channel comprises at least one, preferably a plurality of fluid output opening(s), in particular regularly distributed along the maximum extension of the fluid channel, e.g., a channel-like feedthrough to an external region with a constant maximum transverse extension and/or a nozzle element, for a fluid output.

The fluid output unit is provided for transporting wiper fluid and/or cleaning fluid and comprises at least the further fluid channel for this purpose. The further fluid channel can at least partially, preferably for the most part, be designed as a hose and/or as a tube. The further fluid channel is preferably delimited at least partially, preferably for the most part, by a single-part or multi-part, preferably elastic, hose and/or a single-part or multi-part tube. Preferably, the at least one further fluid channel comprises a constant maximum transverse extension perpendicular to its maximum extension. The additional fluid channel is arranged on the outer side of the wind deflector unit and could, e.g., be glued, clamped, welded and/or fused to the wind deflector unit. The further fluid channel is preferably detachably connected to the outer side of the wind deflector unit, e.g. in an interlocking and/or frictional manner. The at least one fluid channel preferably comprises a connection to an external fluid reservoir. The further fluid channel could be arranged on the outer side of the wind deflector unit on a surface of the wind deflector unit facing a wind, e.g. on the at least one concave inflow surface of the wind deflector unit. The further fluid channel is preferably arranged on a surface of the wind deflector unit facing away from the wind, in particular in order to prevent the flow properties of the wind deflector unit from being influenced by the further fluid channel.

The term “assembled state” is intended to mean a state in which all units and/or elements of the wiper blade device and/or a windshield wiper comprising the wiper blade device, which are essential for its operation, are fully assembled.

The term “operating state” is intended to mean a state in which the wiper blade device and/or the windshield wiper comprising the wiper blade device is/are ready for operation for a wiping process and/or a wiping operation and/or is/are in a wiping operation, in which the wiper lip of the wiper blade device is preferably guided over a vehicle windshield and thereby advantageously abuts against the vehicle windshield.

In the present document, numerical words such as “first” and “second” which precede certain terms are merely used in order to distinguish objects and/or assign objects to one another and do not imply an existing total number and/or ranking of the objects. In particular, the term “second object” does not necessarily imply the presence of a “first object”.

The term “provided” is preferably intended to mean specifically configured, specifically designed and/or specifically equipped. The expression “an object being provided for a specific function” is preferably intended to mean that the object fulfils and/or performs this specific function in at least one application and/or operating state.

The embodiment of the wiper blade device according to the invention can advantageously increase efficiency. Advantageously, a targeted spraying of a wiper and/or cleaning fluid onto a sensor which is arranged above a windshield of a vehicle, e.g. a lidar sensor arranged in or on a roof of the vehicle, can be made possible so that an additional cleaning system is no longer required for the sensor. This has the advantage of reducing the technical complexity of designing lidar sensors for autonomous driving. A lidar sensor can therefore be integrated into a vehicle particularly easily, as only the corresponding electronics and no integrated cleaning mechanism is required. This can advantageously reduce manufacturing and/or assembly costs in the production of vehicles comprising lidar sensors and improve material and cost efficiency.

The at least one further fluid channel could extend along the longitudinal axis of the wind deflector unit over at least 15%, in particular over at least 20%, advantageously over at least 25%, particularly advantageously over at least 30% and preferably over at least 35% of the maximum longitudinal extension of the wind deflector unit. In a particularly preferred embodiment, it is proposed that the at least one further fluid channel extends along the longitudinal axis of the wind deflector unit over at least 40% of the maximum longitudinal extension of the wind deflector unit. This can advantageously further improve a targeted fluid output, in particular a targeted spraying, of wiper and/or cleaning fluid onto a sensor arranged above a vehicle windshield, in particular a lidar sensor. The wiper blade device preferably comprises an end cap. Preferably, the at least one further fluid channel extends along the longitudinal axis of the wind deflector unit to an end of the wind deflector unit at which the end cap is mounted. The at least one further fluid channel can extend along the longitudinal axis of the wind deflector unit over at least 50%, in particular over at least 75% of the maximum longitudinal extension of the wind deflector unit. It is also conceivable that the at least one further fluid channel extends along the longitudinal axis of the wind deflector unit over the entire maximum longitudinal extension of the wind deflector unit.

In addition, it is proposed that the fluid output unit comprises at least one fluid output element connected to the further fluid channel for fluid output in a direction at least substantially parallel to the longitudinal axis of the wind deflector unit. Such an embodiment can advantageously further improve targeted fluid output, in particular targeted spraying, of wiper and/or cleaning fluid onto a sensor arranged above a vehicle windshield, in particular a lidar sensor. The fluid output element comprises at least one fluid dispensing nozzle and/or is designed as a fluid dispensing nozzle. The fluid output unit can comprise a housing in which the fluid output element is arranged. The fluid output element can be designed as a fluid dispensing nozzle.

It is also conceivable that the fluid output unit comprises a plurality of fluid output elements, which are arranged together in the housing and are each provided for fluid output in a direction at least substantially parallel to the longitudinal axis of the wind deflector unit. The term “substantially parallel” is in particular intended to mean an alignment of a direction relative to a reference direction, in particular in a plane, whereby the direction has a deviation relative to the reference direction, in particular less than 8°, advantageously less than 5° and particularly advantageously less than 2°.

In an advantageous embodiment, it is proposed that the fluid output element is arranged in a cross-section perpendicular to the longitudinal axis of the wind deflector unit offset relative to the at least one further fluid channel. This can advantageously further improve targeted fluid output, in particular targeted spraying, of wiper and/or cleaning fluid onto a sensor arranged above a vehicle windshield, in particular a lidar sensor. In particular, an improved alignment of the fluid output element can be made possible if this is arranged in a cross-section perpendicular to the longitudinal axis of the wind deflector unit offset relative to the at least one further fluid channel.

It is further proposed that the wiper blade unit comprises at least one end cap in which the at least one fluid output element is arranged. Such an embodiment can advantageously further improve efficiency. If the fluid output element is arranged in the end cap, an additional housing can advantageously be omitted. It is also conceivable that the fluid output unit comprises a plurality of fluid output elements, which are arranged in the end cap. Preferably, the at least one further fluid channel opens into the end cap and is connected to it, in particular detachably, e.g. by screwing. A connecting region between the further fluid channel and the end cap is sealed against fluid leakage, e.g. by means of a sealing ring or the like. In this embodiment, the end cap preferably comprises at least one inner flow channel, which connects the further fluid channel to the fluid output element.

It is also proposed that the wind deflector unit comprises at least one spoiler element on which the at least one further fluid channel is arranged. This can advantageously achieve an improved, in particular space-saving, arrangement of the at least one further fluid channel. Preferably, the spoiler element forms the at least one concave inflow surface of the wind deflector unit. Preferably, the at least one further fluid channel is arranged on a surface of the spoiler element facing away from the wind. The wind deflector unit could comprise a plurality of, e.g., at least two spoiler elements, whereby the at least one further fluid channel is arranged on exactly one of the spoiler elements.

Furthermore, it is proposed that the wiper blade unit comprises at least one connecting element which connects the at least one further fluid channel to the wind deflector unit. Such an embodiment can advantageously improve assembly. Preferably, the connecting element is intended to detachably connect the further fluid channel to the wind deflector unit, in particular to enable simple replacement of the further fluid channel. Preferably, the connecting element is connected to the wind deflector unit, preferably to the spoiler of the wind deflector unit, in particular in a bonded manner. The connecting element could, e.g., be designed as an elastic element, e.g. as a spring element and/or as a clamping element and/or the like, so that the further fluid channel can be clamped and/or restrained between the connecting element and the outer side of the wind deflector unit in an assembled state of the wiper blade device. The term “elastic element” is intended to mean an element that can be repeatedly deformed without the element being mechanically damaged or destroyed as a result, and that automatically returns to a basic shape after deformation. The connecting element could alternatively or additionally be designed as an interlocking element, e.g. as a hose clamp or the like, and be intended to engage in an interlocking manner around the additional fluid channel for attachment to the wind deflector unit. Other connecting elements that appear advantageous to the skilled person are conceivable.

The invention also relates to a windshield wiper comprising at least one wiper arm unit and comprising a wiper blade device according to one of the embodiments described hereinabove. Such a windshield wiper is characterized in particular by the advantageous properties specified hereinabove of the wiper blade device, which, in addition to conventional cleaning of vehicle windscreens, advantageously additionally enables cleaning of an object arranged above the vehicle windscreen, in particular a sensor, preferably a lidar sensor. The windshield wiper is preferably intended for use on vehicles that comprise a lidar sensor arranged above a vehicle windshield. However, one application of the windshield wiper according to the invention is not limited to vehicles comprising a lidar sensor. For example, the windshield wiper according to the invention could be designed as a rear windshield wiper, whereby a brake light arranged above the rear windshield could be cleaned by means of the fluid output unit. Preferably, the wiper arm unit is intended to be connected to commercially available wiper arms of vehicles, so that used and/or already developed vehicles can also be retrofitted with the windshield wiper according to the invention.

Furthermore, it is proposed that the windshield wiper comprises a valve unit which comprises at least one valve element which is designed to stop and/or enable a fluid flow through the at least one further fluid channel as a function of a wiping angle. Such an embodiment can advantageously enable particularly targeted and efficient cleaning of a sensor arranged above the vehicle windshield, in particular a lidar sensor. In particular, an efficient use of wiper fluid and/or cleaning fluid can be made possible if the valve element is designed to stop and/or enable a fluid flow through the at least one further fluid channel depending on a wiping angle. Preferably, the wiping angle is measured clockwise starting from a lower edge of the surface to be wiped, e.g. a vehicle windshield, and can assume values between 0° and 180°. Preferably, the valve element is designed to stop the fluid flow through the at least one further fluid channel in at least one angular range of the wiping angle and to enable it in at least one further angular range of the wiping angle. For example, the valve element could be designed to stop the fluid flow through the at least one further fluid channel in a first angular range, which could, e.g., include wiping angles between 0° and 70°, to enable the fluid flow through the at least one further fluid channel in a second angular range, which could, e.g., include wiping angles between 70° and 110°, and to block the fluid flow through the at least one further fluid channel again in a third angular range, which could, e.g., include wiping angles between 110° and 180°. The valve element can clearly also be designed to stop and/or enable the flow of fluid through the at least one further fluid channel in angular ranges of the wiping angle other than those specified hereinabove. Preferably, the angular ranges of the wiping angle, in which a fluid flow through the at least one further fluid channel is stopped or enabled, are freely adjustable, which advantageously enables flexible adaptation to different geometries and/or sizes and/or positions of objects to be cleaned, in particular lidar sensors, in different vehicles.

The invention also relates to a method for operating a windshield wiper according to the invention.

It is proposed that a fluid output is performed via the at least one further fluid channel of the fluid output unit as a function of a wiping angle. Such a method can advantageously enable targeted and efficient cleaning of an object arranged above a vehicle windshield, in particular a lidar sensor.

The wiper blade device according to the invention, the windshield wiper according to the invention and the method according to the invention is/are not intended to be limited to the application and embodiment described hereinabove. The wiper blade device according to the invention, the windshield wiper according to the invention and/or the method according to the invention can in particular comprise a number of individual elements, components and units and method steps that deviates from a herein mentioned number in order to fulfill a herein described function. Moreover, regarding the ranges of values indicated in this disclosure, values lying within the limits specified hereinabove are also intended to be considered as disclosed and usable as desired.

### BRIEF DESCRIPTION OF THE DRAWINGS

Further advantages follow from the description of the drawings hereinafter. The drawings illustrate two exemplary embodiments of the invention. The drawings, the description, and the claims contain numerous features in combination. The skilled person will appropriately also consider the features individually and combine them into additional advantageous combinations.

Shown are:

FIG. 1 a windshield wiper comprising a wiper arm unit and a wiper blade device in a schematic representation,

FIG. 2 a schematic sectional view of the wiper blade device,

FIG. 3 a schematic perspective partial view of the wiper blade device,

FIG. 4 a schematic diagram illustrating the operation of the windshield wiper,

FIG. 5 a schematic process flow diagram illustrating a process for operating the windshield wiper, and

FIG. 6 a further exemplary embodiments of a wiper blade device in a schematic perspective partial view.

### DETAILED DESCRIPTION

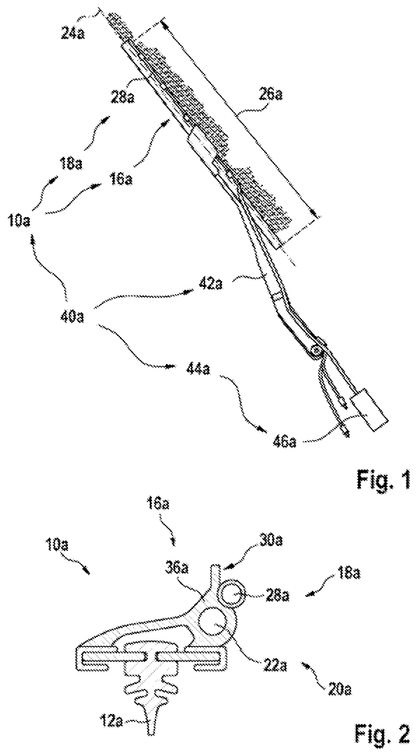

FIG. 1 shows a windshield wiper 40a in a schematic representation. The windshield wiper 40a comprises at least one wiper arm unit 42a and a wiper blade device 10a. In an assembled state of the windshield wiper 40a, the wiper blade device 10a is connected to the wiper arm unit 42a.

The wiper blade device 10a comprises at least one wiper lip 12a (see FIG. 2) for wiping a surface 14a (see FIG. 4). The wiper blade device 10a comprises a wind deflector unit 16a for utilizing an airstream to press the wiper lip 12a against the surface 14a.

The wiper blade device 10a comprises a fluid unit 20a (see FIG. 2) for guiding wiper

fluid to a fluid output. The fluid unit 20a comprises at least one fluid channel 22a (see FIG. 2) delimited by the wind deflector unit 16a. The fluid channel 22a extends along a longitudinal axis 24a of the wind deflector unit 16a over at least 10% of a maximum longitudinal extension 26a of the wind deflector unit 16a.

The wiper blade device 10a comprises a fluid output unit 18a comprising at least one further fluid channel 28a. The at least one further fluid channel 28a extends along the longitudinal axis 24a of the wind deflector unit 16a over at least 10% of the maximum longitudinal extension 26a of the wind deflector unit 16a. In the present case, the at least one further fluid channel 28a extends along the longitudinal axis 24a of the wind deflector unit 16a over at least 40% of the maximum longitudinal extension 26a of the wind deflector unit 16a.

The windshield wiper 40a comprises a valve unit 44a comprising at least one valve element 46a. In an operating state of the windshield wiper 40a, a fluid flow through the at least one further fluid channel 28a of the fluid output unit 18a can be controlled and/or regulated via the valve element 46a.

FIG. 2 shows the wiper blade device 10a in a schematic sectional view, whereby the section is perpendicular to the longitudinal axis 24a (see FIG. 1) of the wind deflector unit 16a.

The further fluid channel 28a of the wind deflector unit 16a is arranged at least partially outside the wind deflector unit 16a on an outer side 30a of the wind deflector unit 16a. In the present case, the further fluid channel 16a is arranged on the outer side 30a in a region which, in an operating state of the windshield wiper 40a, faces away from a wind.

The wind deflector unit 16a comprises at least one spoiler element 36a. The at least one further fluid channel 28a of the wind deflector unit 16a is arranged on the spoiler element 36a of the wind deflector unit 16a. The fluid channel 22a of the fluid unit 20a is delimited by the spoiler element 36a of the wind deflector unit 16a. In the present case, the fluid channel 22a of the fluid unit 20a is arranged inside the spoiler element 36a of the wind deflector unit 16a.

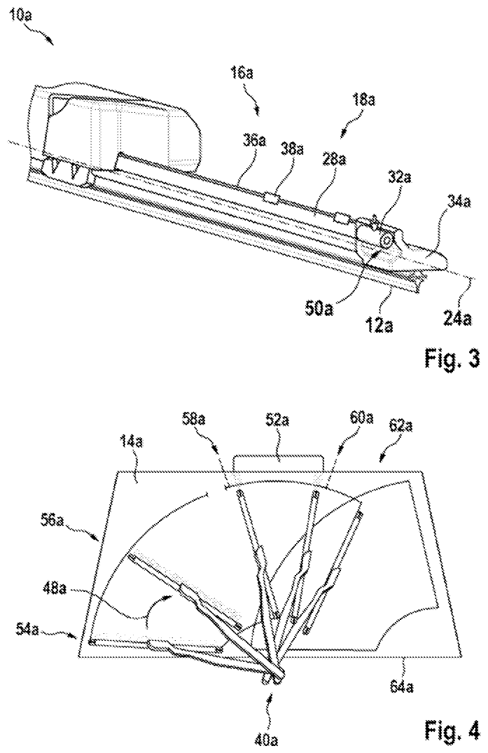

FIG. 3 shows the wiper blade device 10a in a schematic perspective partial view.

The fluid output unit 18a comprises at least one fluid output element 32a connected to the further fluid channel 28a for fluid output in a direction at least substantially parallel to the longitudinal axis 24a of the wind deflector unit 16a. The fluid output unit 18a comprises a housing in which the fluid output element 32a is arranged. The fluid output element 32a is designed as a fluid dispensing nozzle and is arranged at one end of the housing, connected thereto and aligned parallel to the longitudinal axis 24a of the wind deflector unit 16a. In the present case, the fluid output unit 18a comprises exactly one fluid output element 32a. Alternatively, however, the fluid output unit 18a could also comprise a plurality of fluid output elements 32a, which could be arranged at different locations of the housing. The housing, in which the fluid output element 32a is arranged, is connected to the further fluid channel 28a in an interlocking and/or bonded manner. The housing is detachably connected to the further fluid channel 28a, e.g. screwed, in order to enable easy replacement of the fluid output element 32a.

The wiper blade device 10a comprises an end cap 34a. In the present exemplary embodiment, the fluid output element 32a is arranged on an outer side of the end cap 34a in a gap 50a of the end cap 34a. The housing of the fluid output unit 18a is connected in a bonded manner to the end cap 34a in a beginning of the gap 50a.

The wiper blade device 10a comprises at least one connecting element 38a, which connects the at least one further fluid channel 28a to the wind deflector unit 16a. In the present case, the wiper blade device 10a comprises two connecting elements 38a, which connect the at least one further fluid channel 28a to the wind deflector unit 16a and which are arranged offset relative to one another with respect to the longitudinal axis 24a of the wind deflector unit 16a. In the present case, the connecting elements 38a are designed as elastically deformable clamping elements and are connected to the spoiler element 36a of the wind deflector unit 16a, so that the further fluid channel 28a which can, e.g., be formed by a hose, is clamped between the connecting elements 38a and the outer side 30a (see FIG. 2) of the wind deflector unit 16a in the assembled state.

In the drawings, only one of the multiple objects present is indicated by a reference character.

FIG. 4 shows a schematic diagram illustrating a mode of operation of the windshield wiper 40a. In FIG. 4, the windshield wiper 40a is shown in five different positions 54a, 56a, 58a, 60a, 62a on the surface 14a. In the present case, the surface 14a is a windshield of a vehicle (not shown). The vehicle comprises a sensor 52a, which can, e.g., be designed as a lidar sensor and can be intended to support autonomous driving. The sensor 52a is arranged above the surface 14a, which is designed as a windshield, in a roof of the vehicle. The windshield wiper 40a is intended to clean the sensor 52a in addition to the conventional cleaning of the surface 14a in the form of a windshield.

The valve element 46a of the valve unit 44a (see FIG. 1) of the windshield wiper 40a is designed to stop and/or enable a fluid flow through the at least one further fluid channel 28a as a function of a wiping angle 48a.

The wiping angle 48a is measured starting from a lower edge 64a of the surface 14a. In a first position 54a, the windshield wiper 40a is in a rest position, whereby the wiping angle 48a is between 0° and 10°. In a second position 56a, the windshield wiper 40a is in a normal operating mode for cleaning the surface 14a and is moved clockwise along a segment of a circle via the wiper arm unit 42a (see FIG. 1). In the normal operating mode, wiper fluid is transported via the fluid channel 22a of the fluid unit 20a (see FIG. 2) and sprayed onto the surface 14a via fluid dispensing elements (not shown), e.g. openings and/or nozzles in the fluid channel 22a, of the fluid unit 20a in a direction substantially perpendicular to the longitudinal axis 24a of the wind deflector unit 16a (see FIG. 1) and the surface 14a is cleaned by means of the wiper lip 12a of the wiper blade device 10a (see FIG. 2). In a third position 58a, the windshield wiper 40a switches from the normal operating mode to an additional operating mode, whereby, in addition to cleaning the surface 14a, the sensor 52a is also cleaned. In the additional operating mode, the valve 46a of the valve unit 44a is open and allows a fluid flow through the at least one further fluid channel 28a of the fluid output unit 18a. In the additional operating mode, a cleaning fluid is transported via the further fluid channel 28a to the fluid output element 32a (see FIG. 3) and is output in a direction at least substantially parallel to the longitudinal axis 24a of the wind deflector unit 16a. In the present exemplary embodiments, the wiping angle 48a in the third position 58a is, e.g., about 70°. In a fourth position 60a, the additional operating mode is terminated again by closing the valve 46a and stopping a fluid flow through the at least one further fluid channel 28a. At the fourth position 60a, the windshield wiper 40a switches from the additional operating mode back to the normal operating mode. In the present exemplary embodiment, the wiping angle 48a in the fourth position 60a is, e.g., approximately 110°. Depending on the geometry, size and position of the sensor 52a, other wiping angles 48a would clearly also be conceivable, at which the fluid flow through the at least one further fluid channel 28a can be enabled or stopped via the valve 46a. Preferably, the wiping angles 48a at which the fluid flow through the at least one further fluid channel 28a can be enabled or stopped via the valve 46a are freely adjustable to enable the wiper blade device 10a to be used on a wide variety of vehicles and/or for other applications. At a fifth position 62a, a direction of movement of the windshield wiper 40a is reversed and the windshield wiper 40a is moved back counterclockwise in the normal operating mode. Optionally, the additional operating mode can be reactivated at the fourth position 60a during the return movement and deactivated again at the third position 58a. It is also conceivable that the windshield wiper 40a is operated exclusively in the normal operating mode during the return movement.

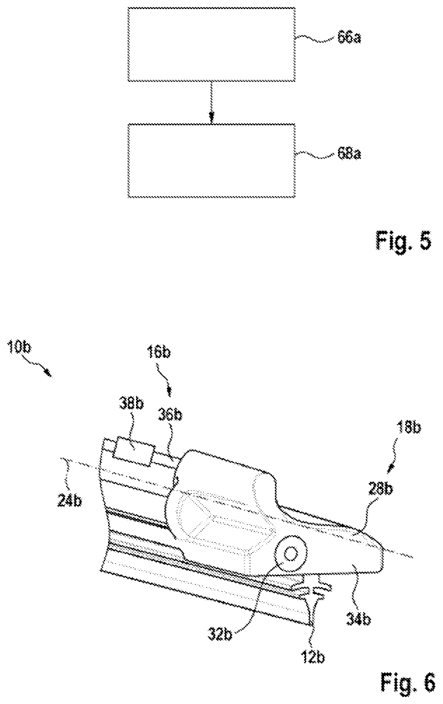

FIG. 5 shows a schematic process flow diagram of a process for operating the windshield wiper 40a. In the method, a fluid output is performed via the further fluid channel 28a as a function of the wiping angle 48a. The method comprises at least two method steps. In a first method step 66a of the method, the windshield wiper 40a is operated in the previously described normal operation mode and is moved with the wiper lip 12a clockwise on the surface 14a, whereby no fluid output is performed via the further fluid channel 28a of the fluid output unit 18a because an amount of the wiping angle 48a is outside a predetermined angular range for the additional operation mode. As soon as the wiping angle 48a reaches a first predetermined amount, e.g. the amount of approximately 70° shown in the third position 58a in FIG. 4, a second method step 68a of the method begins. In the second method step 68a, the windshield wiper 40a is operated in the previously described additional operating mode, whereby a fluid output is provided via the further fluid channel 28a of the fluid output unit 18a, e.g. for cleaning the sensor 52a shown in FIG. 4. As soon as the wiping angle 48a reaches a second predetermined amount, e.g. the amount of approximately 110° shown in the fourth position 60a in FIG. 4, a fluid output via the further fluid channel 28a of the fluid output unit 18a is stopped again in the second method step 68a and the windshield wiper 40a is then operated again in the normal operating mode, whereby the wiper lip 12a is moved clockwise to an end point, e.g. the fifth position 62a shown in FIG. 4. In one or more optional further method step(s) of the method, the wiper lip 12a is moved counterclockwise starting from the end point on the surface 14a and initially operated in the normal mode, whereby from reaching the second predetermined amount of the wiping angle 48a until reaching the first predetermined amount of the wiping angle 48a, fluid can optionally again be dispensed via the further fluid channel 28a of the fluid output unit 18a and the windshield wiper 40a can be operated in the additional operating mode.

FIG. 6 shows another exemplary embodiment of the invention. The following descriptions and the drawings are substantially limited to the differences between the exemplary embodiments, whereby, with respect to identically designated components, in particular with respect to components having the same reference characters, reference can in principle also be made to the drawings and/or the description of the other exemplary embodiments, in particular in FIGS. 1 to 5. In order to distinguish between the exemplary embodiments, the letter a is appended to the reference characters for the exemplary embodiment in FIGS. 1 to 5. In the exemplary embodiment in FIG. 6, the letter a is replaced by the letter b.

FIG. 6 shows a further exemplary embodiment of a wiper blade device 10b in a schematic representation. The wiper blade device 10b comprises at least one wiper lip 12b for wiping a surface (not shown). The wiper blade device 10b comprises a wind deflector unit 16b for utilizing an airstream to press the wiper lip 12b against the surface.

Similar to the preceding exemplary embodiment, the wiper blade device 10b comprises a fluid unit (not shown) for guiding wiper fluid to a fluid output. The fluid unit of the wiper blade device 10b comprises at least one fluid channel (not shown here, see fluid channel 22a in FIG. 2) delimited by the wind deflector unit 16b. The fluid channel extends along a longitudinal axis 24b of the wind deflector unit 16b over at least 10% of a maximum longitudinal extension (not shown here, see longitudinal extension 26a in FIG. 1) of the wind deflector unit 16b.

The wiper blade device 10b is part of a windshield wiper (not shown) and differs from the wiper blade device 10a of the preceding exemplary embodiment essentially with respect to an embodiment of a fluid output unit 18b. Similar to the fluid output unit 18a of the preceding exemplary embodiment, the fluid output unit 18b comprises at least one further fluid channel 28b, which extends along the longitudinal axis 24b of the wind deflector unit 16b over at least 10% of the maximum longitudinal extension of the wind deflector unit 16b and which is arranged at least partially outside the wind deflector unit 16b on an outer side of the wind deflector unit 16b.

The fluid output unit 18b comprises at least one fluid output element 32b connected to the further fluid channel 28b for fluid output in a direction at least substantially parallel to the longitudinal axis 24b of the wind deflector unit 16b. In contrast to the preceding exemplary embodiment, the fluid output element 32b is not directly, but indirectly connected to the further fluid channel 28b. The wiper blade device 10b comprises an end cap 34b. In the present exemplary embodiment, the fluid output element 32b is arranged in the end cap. The further fluid channel 28b opens into the end cap 34b and is connected to it, e.g. via a screw connection. A further difference from the preceding exemplary embodiment is that the fluid output unit 18b is designed without a housing, and the fluid output element 32b is integrated directly into the end cap 34b. A flow channel (not shown) extends within the end cap 34b, which connects the further fluid channel 28b to the fluid output element 32b.

In contrast to the preceding exemplary embodiment, the fluid output element 32b is arranged in a cross-section perpendicular to the longitudinal axis 24b of the wind deflector unit 16b offset relative to the at least one further fluid channel 28b.

1. A wiper blade device (10a; 10b) comprising:
at least one wiper lip (12a; 12b) for wiping a surface (14a), and
at least one wind deflector unit (16a; 16b) for utilizing an airstream to press the wiper lip (12a; 12b) against the surface (14a),
a fluid output unit (18a; 18b), and
a fluid unit (20a) for guiding wiper fluid to a fluid output, which fluid unit comprises at least one fluid channel (22a) delimited by the wind deflector unit (16a; 16b), which channel extends along a longitudinal axis (24a; 24b) of the wind deflector unit (16a; 16b) over at least 10% of a maximum longitudinal extension (26a) of the wind deflector unit (16a; 16b),
wherein the fluid output unit (18a; 18b) comprises at least one further fluid channel (28a; 28b), which extends along the longitudinal axis (24a) of the wind deflector unit (16a; 16b) over at least 10% of the maximum longitudinal extension (26a) of the wind deflector unit (16a; 16b), and which is arranged at least partially outside the wind deflector unit (16a; 16b) on an outer side (30a) of the wind deflector unit (16a; 16b).

2. The wiper blade device (10a; 10b) according to claim 1, wherein the at least one further fluid channel (28a; 28b) extends along the longitudinal axis (24a; 24b) of the wind deflector unit (16a; 16b) over at least 40% of the maximum longitudinal extension (26a) of the wind deflector unit (16a; 16b).

3. The wiper blade device (10a; 10b) according to claim 1, wherein the fluid output unit (18a; 18b) comprises at least one fluid output element (32a; 32b) connected to the further fluid channel (28a; 28b) for fluid output in a direction at least substantially parallel to the longitudinal axis (24a; 24b) of the wind deflector unit (16a; 16b).

4. The wiper blade device (10b) according to claim 3, wherein the fluid output element (32b) is arranged in a cross-section perpendicular to the longitudinal axis (24b) of the wind deflector unit (16b) offset relative to the at least one further fluid channel (28b).

5. The wiper blade device (10b) according to claim 3, further comprising at least one end cap (34b), in which the at least one fluid output element (32b) is arranged.

6. The wiper blade device (10a; 10b) according to claim 1, wherein the wind deflector unit (16a; 16b) comprises at least one spoiler element (36a; 36b), on which the at least one further fluid channel (28a; 28b) is arranged.

7. The wiper blade device (10a; 10b) according to claim 1, further comprisingcharacterized by at least one connecting element (38a; 38b), which connects the at least one further fluid channel (28a; 28b) to the wind deflector unit (16a; 16b).

8. A windshield wiper (40a) comprising at least one wiper arm unit (42a) and comprising a wiper blade device (10a; 10b) according to claim 1.

9. The windshield wiper (40a) according to claim 8, further comprising a valve unit (44a) which comprises at least one valve element (46a), which is designed configured to stop and/or enable a fluid flow through the at least one further fluid channel (28a; 28b) as a function of a wiping angle (48a).

10. A method for operating a windshield wiper (40a) according to claim 8, wherein a fluid output is performed via the at least one further fluid channel (28a; 28b) of the fluid output unit (18a; 18b) as a function of a wiping angle (48a).

11. The wiper blade device (10a; 10b) according to claim 2, wherein the fluid output unit (18a; 18b) comprises at least one fluid output element (32a; 32b) connected to the further fluid channel (28a; 28b) for fluid output in a direction at least substantially parallel to the longitudinal axis (24a; 24b) of the wind deflector unit (16a; 16b).

12. The wiper blade device (10b) according to claim 4, further comprising at least one end cap (34b), in which the at least one fluid output element (32b) is arranged.
